(19) United States
(12) Patent Application Publication
(10) Pub. No.: US 2013/0271462 A1
(43) Pub. Date: Oct. 17, 2013

(54) MULTI-COMPONENT METHOD OF CREATING COMPUTER MODELS OF REAL ESTATE PROPERTIES FOR THE PURPOSE OF CONDUCTING VIRTUAL AND INTERACTIVE REAL ESTATE TOURS

(71) Applicant: Sean Frank, Orlando, FL (US)

(72) Inventor: Sean Frank, Orlando, FL (US)

(21) Appl. No.: 13/861,562

(22) Filed: Apr. 12, 2013

Related U.S. Application Data
(60) Provisional application No. 61/624,498, filed on Apr. 16, 2012.

(51) Int. Cl. G06Q 50/16; G06T 19/00

(52) U.S. Cl. CPC G06Q 50/16; G06T 19/006
USPC 345/420

(57) ABSTRACT

A new and useful multi-component method of creating computer models of real estate properties for the purpose of conducting virtual and interactive real estate tours. The present invention comprises a 3D mapping component where a 3D model of a property is created using a 3D modeling program, and a 3D walkthrough component where panoramic photos are created and interconnected to create a virtual tour of the interior spaces of the property. A method according to the present invention is believed to allow a user to virtually tour the exterior and interior of a property remotely on their computer, on their own schedule, and other benefits over still photos and current listing practices.

### CROSS-REFERENCE TO RELATED APPLICATIONS

This Application claims the benefit of U.S. Provisional Application No. 61/624,498, filing date Apr. 16, 2012.

### TECHNICAL FIELD

This invention relates generally to a method of conducting real estate showings and tours. More specifically this invention relates to a multi-component method of creating computer models of real estate properties for the purpose of conducting remote, virtual and interactive real estate tours.

### BACKGROUND OF THE INVENTION

In the current art, real estate property listings are presented with static text and still photographs in mediums like newspapers, circulars and web pages. These still photographs are often less than ideal and fail to show the entire space clearly. In order for an interested buyer to learn more about the property in the listing, she must then communicate with a real estate agent and visit the property in person. This practice of physically touring multiple properties, called walkthroughs, is time consuming, difficult to schedule, and often fruitless for all involved.

Further, virtual tours in the current art merely implement traditional two-dimensional photos in a gallery format. In rare circumstances the photos pan in different directions to create the illusion of movement, but do not offer any significant improvement over other physical flat media. Over time, the phrase “virtual tour” has been used as a largely exaggerated and inaccurate moniker. At best it is merely puffery—completely lacking any nexus with the state of current technology. Current products offered under the mislabeled moniker of “virtual tour” 1) do not implement any virtual components other than internet functionality, 2) do not allow one to tour a property in a manner that is representative of an in-person tour, 3) force the user to see one fixed viewpoint of the traditional media, and 4) do not allow the user to dynamically change viewpoints at will.

In the applicant's experience there is a deficiency in the existing and prior art wherein there is no new and useful method that allows buyers and sellers of real property to utilize computer technology to tour properties remotely, virtually and conveniently. The advantages of this invention over the existing art include: i) a user can virtually tour the exterior and interior of a property remotely on their computer, ii) a user can conduct a tour on their own schedule, iii) allows the user to better understand the complete floor plan of the space, how the rooms interconnect, relationships of scale and amenities, iv) the user can direct the pace and path through and around the 3D model exterior and interior, v) provides innumerable benefits over still photos and current listing practices, vi) the real estate agent can avoid unnecessary in-person showings, and vii) the real estate agent can save time by virtually showing properties to the buyer in order to understand more quickly what she seeks. Overall the present invention which allows interactive online showing of properties increases efficiency and benefits to both the user and real estate agent. The method of the present invention is believed to accomplish all of the foregoing objectives.

### SUMMARY OF THE INVENTION

The present invention provides a new and useful method that allows buyers and sellers of real property, to utilize computer technology to tour properties remotely, virtually and conveniently. The advantages of this invention allow a user to virtually tour the exterior and interior of a property remotely on their computer, and conduct a tour on their own schedule. Further, the present invention allows the user to better understand the complete floor plan of the space, how the rooms interconnect, relationships of scale and amenities. While using the present invention, the user can direct the pace and path through and around the 3D model exterior and interior. Benefits extend to the real estate agent as well. Because of the new and useful features of the present invention, a real estate agent can avoid unnecessary in-person showings, and save time by virtually showing properties to the buyer in order to understand more quickly what she seeks.

Also the photos used to create the models in the present invention are taken under ideal conditions, including weather, lighting, decor and cleanliness. This makes for the best possible showing experience every single time. Finally, this method of creating 3D models can contribute to the initiatives relating to populating mapping services like Google Earth with accurate models thereon.

In one of its basic embodiments, the present invention achieves this result by creating a new and useful multi-component method of creating computer models of real estate properties for the purpose of conducting remote and interactive real estate tours. The present invention includes a 3D mapping component and a 3D walkthrough component. The 3D mapping component yields a 3D model and exterior tour of the property. The 3D walkthrough component yields an interior model of the property. Both components result in a visual and interactive means for the buyer and seller to view the property without conducting a physical walkthrough.

The multi-component method of the present invention comprises the steps of first selecting a target property. This property is photographed by a photographer trained in the method of the present invention. The resultant photos are then used to create a 3D mapping component and a 3D walkthrough component—and can be made sequentially or contemporaneously. For the exterior model, hereby referred to as the 3D mapping component, the photographer takes photos of every side, angle, and unique feature of the exterior of the property. Once complete, these photos are used to skin or texture the exterior wireframe of a model created in a 3D modeling program. Google SketchUp is an example of such a program, although any equivalent thereof may suffice.

The next step in the 3D mapping component of the present invention is to optionally upload the complete 3D model for approval by a mapping service or model library. One example of this approval process involves uploading the model to a service like Google 3D Warehouse. Persons there examine the model, for accuracy, conformity and other factors. If the model is approved, the model is integrated into a mapping service, for example Google Earth. If the model is not approved, changes can be made or in the alternative, the model can be hosted on an independent server and manually added to a mapping interface. Application programming interfaces (API), for example Google Earth API, can act as means to effectuate the process.

The second step to the present invention is creating the 3D walkthrough component. This component comprises the steps of photographing the interior of the target property. In this case, the photographer takes multiple photos for each room or area. In order to integrate the multiple photos into one panoramic image, the photographer uses a stationary and single focal point technique. These photos are then stitched together using photo-stitching programs, which align common imagery in photos along a virtual seam. When complete, each room is presented by a single 360 degree panoramic photo. The resultant photos are then uploaded and hosted on an independent server.

Together the exterior model created in the 3D mapping component and interior images created in the 3D walkthrough component of the present invention are incorporated onto useable visual interfaces—usually a website. Using an API, like Google Earth API, a website is developed and includes a mapping service like the Google Earth plug-in. This allows the user to fly to the newly created model, and travel virtually around to the surrounding locations and/or neighborhood.

For the walkthrough component, a similar visual display interface is used. This interface, most likely a website, is coded to load the 360 degree panoramic photos. This is implemented by wrapping the photos on a sphere or cylinder to create the illusion of the viewer freely moving and spinning within the interior space of the target property. Each panoramic photo represents a room and is virtually connected in a manner to mimic the physical floor plan of the property. With arrow key, mouse or other directional input functionality, the user can then conduct a virtual tour through the space by interacting with a selection means such as an icon, link or equivalent.

All of these components can be accessed or combined in a variety of ways to create the total virtual tour. It is envisioned that one embodiment of the present invention displays both components, interior and exterior views, side by side on one display. In another embodiment, each component is displayed one at a time. In another embodiment, both components are presented in a seamless single integrated view, wherein the user can freely transition from the exterior view 3D mapping component to the interior view 3D walkthrough component in real time. It is envisioned that both components can be presented concurrently and simultaneously creating a smooth flow from the exterior of the model to the interior areas. For example, a user using the integrated view would experience a virtual tour which begins with the 3D mapping component displayed on a monitor. Upon commencement, user would see the exterior front of the property and then be allowed to dynamically explore the exterior property model and the surrounding areas. When satisfied, the user selects to enter the property interior by choosing a selection means to the 3D walkthrough component. The selection means could be a link, icon or other object on the screen. Upon selecting the link the camera view dynamically travels or flies from the current position to a view of the exterior model. When the 3D mapping component and the 3D walkthrough component have matching focal points the components transition and replace one another—thereby creating a seamless transition. The seamless transition between the components create the appearance of a singular experience of travelling the property. Although the transition typically occurs when the user enters the property by a front entrance, the transition can occur in other areas as desired. Finally, the transition between the components in the integrated view can be implemented by a number of coding methods, including ubiquitous web languages like javascript, custom programming, or equivalent.

In another embodiment of the present invention, the 3D mapping component can contain links that allow users to dynamically control their viewpoint or experience. For example, one link may cause the virtual camera viewpoint to perform a circular fly-around of the 3D model in low altitude. Another link may perform a fly around at high altitude. The fly-around functionality is deemed to be favorable because users have traditionally found navigating a three dimensional space on a two dimensional monitor confusing and frustrating. During the fly-around of the propery, users are better able to understand the property architecture, scale, lot layout, orientation according to cardinal directions, and other immediately surrounding locales. The fly-around functionality offer the user a dynamic but simple interface that does not require learning three dimensional controls or specific hardware controllers such as joysticks.

In another embodiment, the selection means such as links can be implemented in the 3D walkthrough component to allow the user to change the focal point of each panoramic image. This allows the user to focus on individual points of interest. This may also include links that allow the user to quickly load panoramic environments of new locations—for example another room in the property, property exterior, etc. This allows the user to visit portions of the virtual property quickly without having to traverse the interior model in a linear fashion (i.e. walking room to room).

In another embodiment of the present invention, a feedback form can be implemented alongside the virtual showing.

In another embodiment of the present invention sellers in the market can obtain showing activity and data for each property.

Another possible envisioned use of the present invention could assist potential patrons by allowing them to virtually tour a plurality of venues prior to visiting a particular locale.

Thus the present invention provides a new and useful method that allows buyers and sellers of real property to utilize computer technology to tour properties remotely, virtually and conveniently. The advantages of this invention over the existing art include: i) a user can virtually tour the exterior and interior of a property remotely on their computer, ii) a user can conduct a tour on their own schedule, iii) allows the user to better understand the complete floor plan of the space, how the rooms interconnect, relationships of scale and amenities, iv) the user can direct the pace and path through and around the 3D model exterior and interior, v) provides innumerable benefits over still photos and current listing practices, vi) the real estate agent can avoid unnecessary in-person showings, and vii) the real estate agent can save time by virtually showing properties to the buyer in order to understand more quickly what she seeks. The device of the present invention is believed to accomplish all of the foregoing objectives.

Further features and objectives of the present invention will become apparent form the following detailed description and the accompanying drawings.

### BRIEF DESCRIPTION OF THE DRAWINGS

FIG. 1 is a flow chart enumerating the steps comprising the method of creating 3D real estate tours according to the present invention;

FIG. 2 is a flow chart enumerating the steps comprising the method of creating the 3D mapping component of the present invention;

FIG. 3 is a flow chart enumerating the steps comprising the method of creating the 3D walkthrough component of the present invention;

FIG. 4 is a wire frame screen capture of the 3D mapping component of the present invention as shown in a web browser.

FIG. 5 is a wire frame screen capture of the 3D walkthrough component of the present invention as shown in a web browser.

FIG. 6 is a wire frame screen capture of the side by side view alternative embodiment of the present invention wherein the 3D mapping component and the 3D walkthrough component are shown simultaneously and side by side in a web browser.

FIG. 7 is a wire frame screen capture of the individual view alternative embodiment of the present invention wherein the 3D mapping component and the 3D walkthrough component are shown individually in separate windows of web browser.

FIG. 8 is a wire frame screen capture of the integrated view alternate embodiment of the present invention wherein the view switches seamlessly between the 3D mapping component and the 3D walkthrough component in a web browser.

### DETAILED DESCRIPTION OF THE INVENTION

As described above, the present invention provides a new and useful method that allows buyers and sellers of real property to utilize computer technology to tour properties remotely, virtually and conveniently.

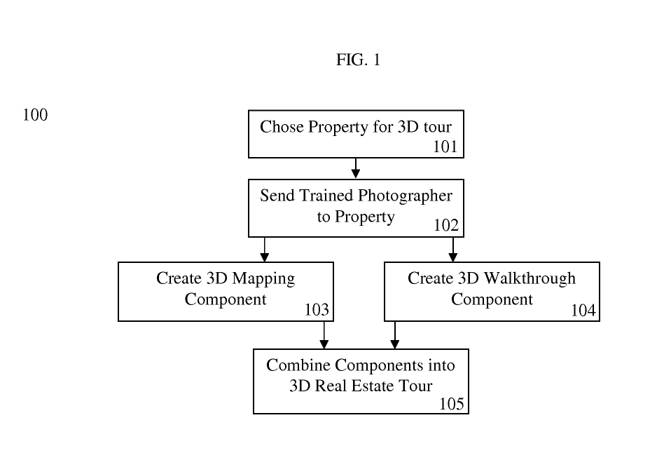

Referring now to the invention in more detail, in FIG. 1 to FIG. 3 there are shown flowcharts enumerating the steps comprising the method of each component of the present invention. Specifically FIG. 1 shows multi-component method of creating 3D computer models of real estate properties for the purpose of conducting virtual and interactive real estate tours comprising the steps of selecting a target property 101, wherein the target property has an exterior space and an interior space. Next the seller or real estate agent sends a photographer trained in the method to a target property 102 to take photographs as required by the subsequent steps which can happen sequentially or contemporaneously and accomplished using the collected photographs.

Using the photographs a 3D mapping component is created using a 3D modeling program 103, wherein the said 3D mapping component is an exterior model of the property. Next a 3D walkthrough component is created using a photo-stitching program 104. The said 3D walkthrough component is an interior model of the property. The final step comprises combining the 3D mapping and walkthrough component for display via an interactive visual interface 105. In the basic embodiment of the present invention the interactive visual interface is envisioned to be a computer web browser which integrates and implements a variety of application programming interfaces (APIs), and plug-ins to display the resultant 3D virtual and interactive real estate tours. The application programming interface can be Google Earth API, Google Maps or equivalent. The plug-in can be Google Earth or equivalent. It is envisioned that the contemporary navigation program is Google Street View or equivalent.

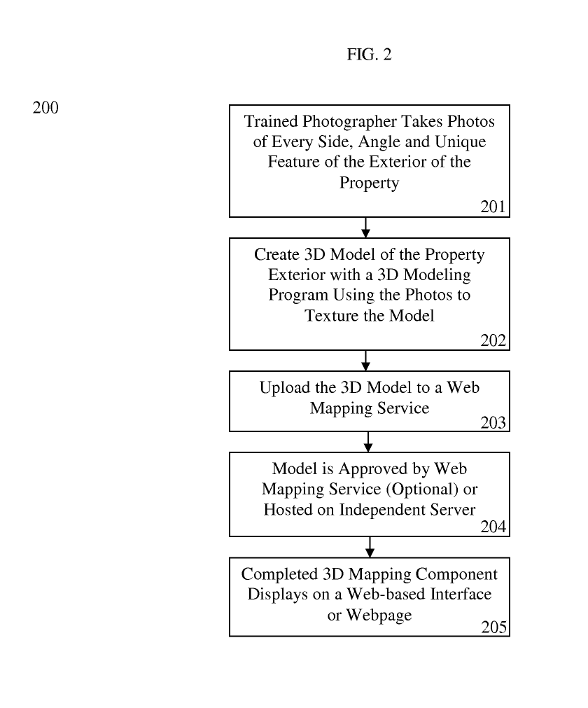

Referring now to FIG. 2, a flowchart is shown enumerating the steps comprising the method of creating the 3D mapping component of the present invention in more detail 200. The 3D mapping component of the present invention is created utilizing steps comprising taking a plurality of photographs of every side, angle, and unique feature of the exterior of the property 201. Thereafter, a 3D model of the exterior of the property is created using the using a 3D modeling program 202, wherein said model is to scale and is textured or skinned using the photographs. The 3D modeling program can be a program like Google SketchUp or an equivalent. This results in a completed and final 3D mapping component 403 for use in the present invention. The seller then uploads the resultant 3D model of the final 3D mapping component 403 to a web mapping service 203. The web mapping service can be Google Maps or an equivalent.

The method of creating the 3D mapping component of the present invention 200 may also further comprise obtaining 3D model approval from a third party 204. Said approval relating to standards of quality, accuracy and integration with existing map services.

In an alternate embodiment of the present invention, the method of creating a 3D mapping component may further comprise hosting a 3D model on an independent server for display.

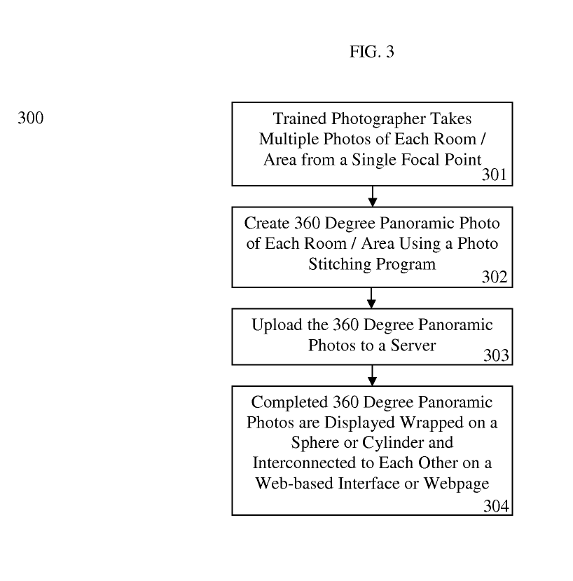

Referring now to FIG. 3, a flowchart is shown enumerating the steps comprising the method of creating the 3D walkthrough component of the present invention 300. The 3D walkthrough component of the present invention is created utilizing steps comprising taking a plurality of photographs of each interior space, room, or area of the property 301. It is envisioned that the photographs of each interior space will be taken from a single focal point. Next the photos for each interior space are stitched into a single 360 degree panoramic photo using a photo-stitching computer program 302. The photo-stitching computer program can be Autostitch or an equivalent. Next, the 360 degree photos are uploaded to a computer server 303.

When the 3D mapping component and 3D walkthrough component are complete, the seller performs the step of using an application programming interface or equivalent to code a webpage to display the 3D mapping component as a real estate tour for viewing, and using plug-ins or equivalent to allow the user to fly to and around the exterior model 205. The method may also further comprise using an application programming interface or equivalent to code a webpage to display the 3D walkthrough component for viewing which allows the user to navigate between interior models in a similar fashion to contemporary navigation programs 304.

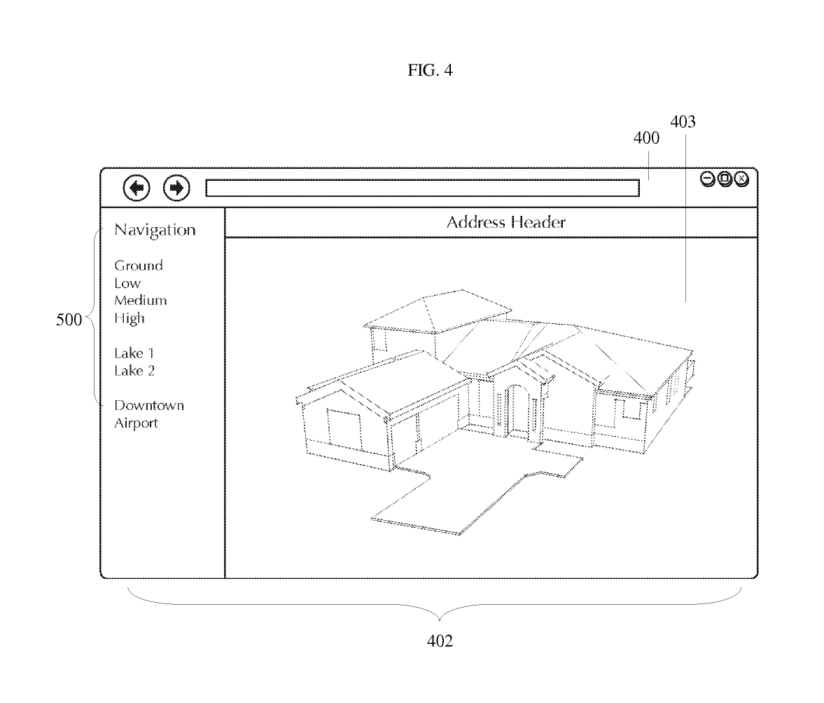

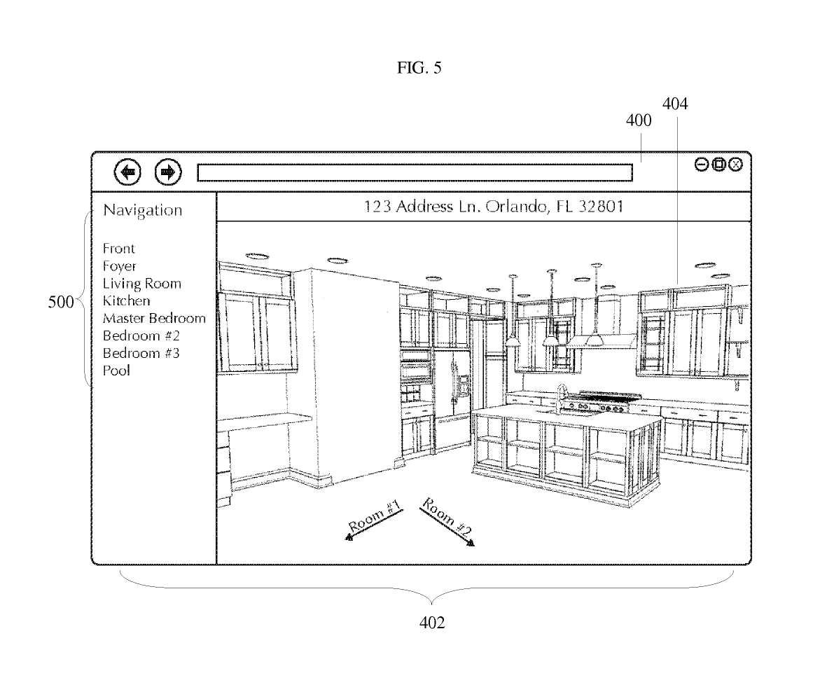

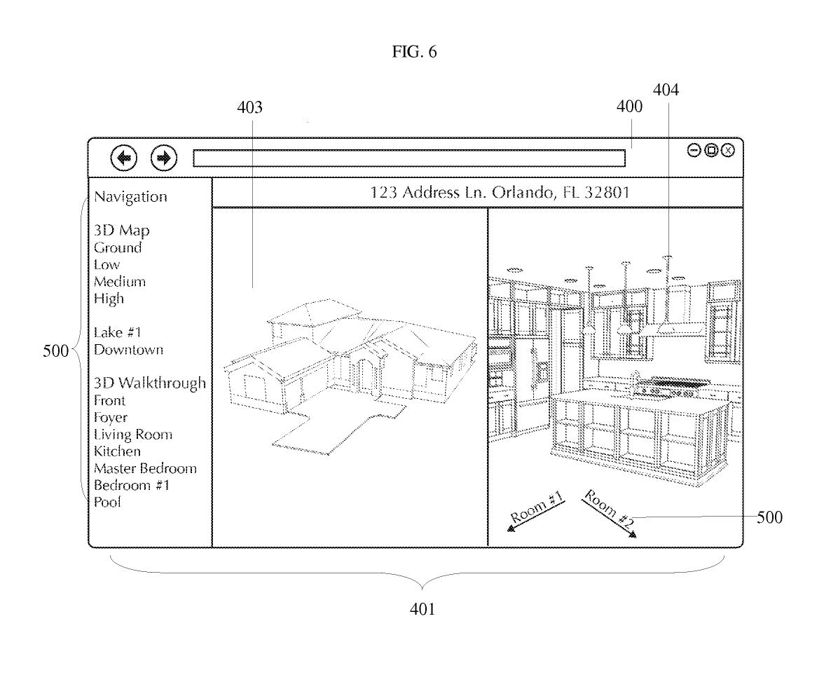

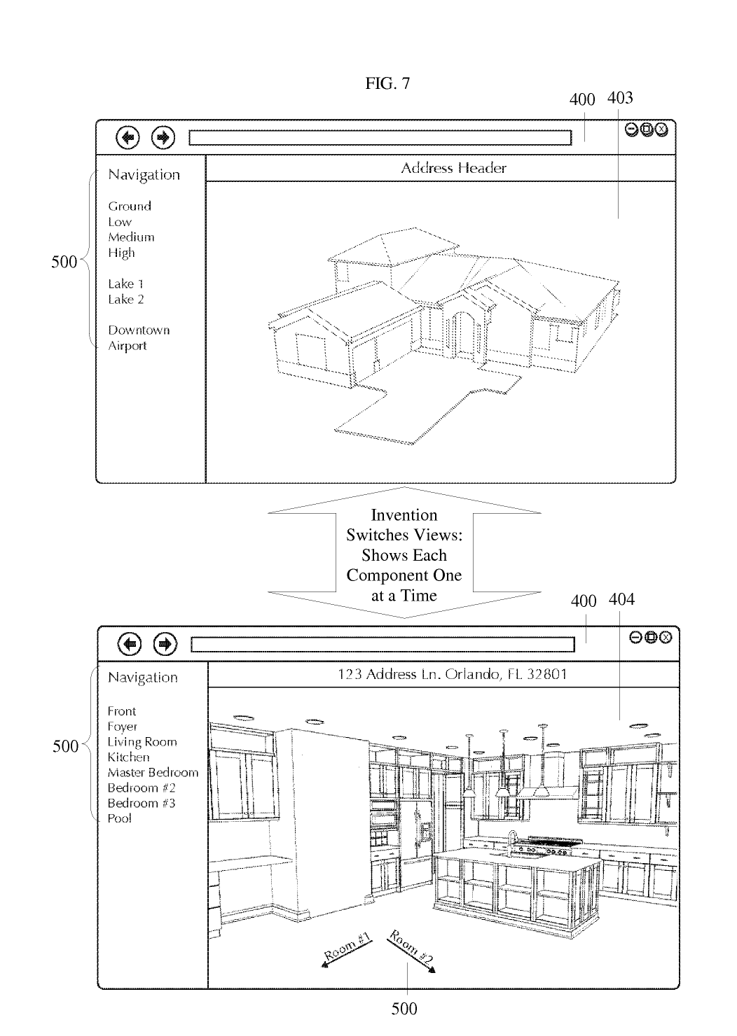

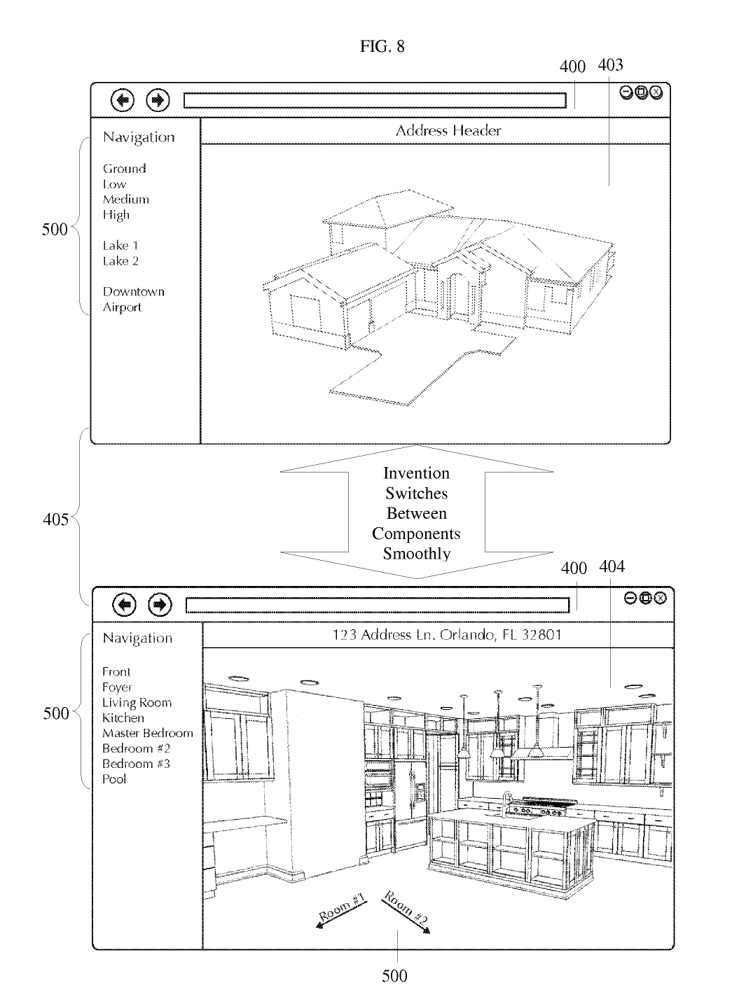

Referring now to FIG. 4 to FIG. 8, wire frame screen captures are shown of various embodiments of the interactive visual interfaces of the present invention. Although the interactive visual interface of the present invention can be any platform available, in one embodiment of the present invention the interactive visual interface is a web browser or equivalent 400.

In an alternate embodiment of the present invention, the interactive visual interface 400 displays the 3D mapping component 403 and 3D walkthrough component 404 in a side-by-side view 401.

In an alternate embodiment of the present invention, the interactive visual interface 400 displays the 3D mapping component 403 and 3D walkthrough component 404 in an individual component view 402.

In an alternate embodiment of the present invention, the interactive visual interface 400 displays the 3D mapping component 403 and 3D walkthrough component 404 in an integrated platform and seamless fashion, allowing the user to tour the entire property virtually.

In the basic embodiment of the present invention, the interactive visual interface further comprises a plurality of selection means for navigating the real estate tour 500, wherein said selection means can be a plurality of links, icons or equivalents.

The previously described versions of the present invention have many advantages including and without limitation, including: i) a user can virtually tour the exterior and interior of a property remotely on their computer, ii) a user can conduct a tour on their own schedule, iii) allows the user to better understand the complete floor plan of the space, how the rooms interconnect, relationships of scale and amenities, iv) the user can direct the pace and path through and around the 3D model exterior and interior, v) provides innumerable benefits over still photos and current listing practices, vi) the real estate agent can avoid unnecessary in-person showings, and vii) the real estate agent can save time by virtually showing properties to the buyer in order to understand more quickly what she seeks. The method of the present invention is believed to accomplish all of the foregoing objectives. The invention does not require that all the advantageous features and all the advantages need to be incorporated into every embodiment of the invention.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A multi-component method of creating 3D computer models of real estate properties for the purpose of conducting virtual and interactive real estate tours comprising:
a) selecting a target property, said property having an exterior space and an interior space;
b) sending a photographer trained in the method to a target property;
c) creating a 3D mapping component using a 3D modeling program, said 3D mapping component is an exterior model of the property;
d) creating a 3D walkthrough component using a photo-stitching program said 3D walkthrough component is an interior model of the property; and
e) combining the 3D mapping and walkthrough component for display via an interactive visual interface.

2. The method in claim 1, wherein the 3D mapping component is created utilizing steps comprising:
a) taking a plurality of photographs of every side, angle, and unique feature of the exterior of the property;
b) creating a 3D model of the exterior of the property using a 3D modeling program, said model is to scale and is textured or skinned using the photographs; and
c) uploading the 3D model to a web mapping service.

3. The method in claim 1, wherein the 3D walkthrough component is created utilizing steps comprising:
a) taking a plurality of photographs of each interior space, room, or area of the property;
b) stitching the photos for each interior space into a single 360 degree panoramic photo using a photo-stitching computer program; and
c) uploading the 360 degree photos to a computer server.

4. The method in claim 1 further comprising using an application programming interface or equivalent to code a webpage to display the 3D mapping component as a real estate tour for viewing, and using plug-ins or equivalent to allow the user to fly to and around the exterior model.

5. The method in claim 1, further comprising using an application programming interface or equivalent to code a webpage to display the 3D walkthrough component for viewing which allows the user to navigate between interior models in a similar fashion to contemporary navigation programs.

6. The method in claim 1 wherein the interactive visual interface is a web browser or equivalent.

7. The method in claim 1 wherein the interactive visual interface displays the 3D mapping component and 3D walkthrough component side-by-side.

8. The method in claim 1 wherein the interactive visual interface displays the 3D mapping component and 3D walkthrough component individually.

9. The method in claim 1 wherein the interactive visual interface displays the 3D mapping component and 3D walkthrough component in an integrated platform and seamless fashion, allowing the user to tour the entire property virtually.

10. The method in claim 2, wherein the 3D modeling program is Google SketchUp or equivalent.

11. The method in claim 2, wherein the web mapping service is Google Maps or equivalent.

12. The method in claim 2, further comprising obtaining 3D model approval from a third party,
said approval relating to standards of quality, accuracy and integration with existing map services.

13. The method in claim 2, further comprising hosting a 3D model on an independent server for display.

14. The method in claim 3, wherein the photographs are taken from a single focal point.

15. The method in claim 3, wherein the photo-stitching program is Autostitch or equivalent.

16. The method in claim 4 wherein the application programming interface is Google Earth API or equivalent.

17. The method in claim 4 wherein the plug-in is Google Earth or an equivalent.

18. The method in claim 5 wherein the application programming interface is Google Maps API or equivalent.

19. The method in claim 5 wherein the contemporary navigation program is Google Street View or an equivalent.

20. The method in claim 1 wherein the interactive visual interface further comprises a plurality of selection means for navigating the real estate tour, said selection means can be a plurality of links, icons or equivalents.
